(19) United States
(12) Patent Application Publication
(10) Pub. No.: US 2016/0360118 A1
(43) Pub. Date: Dec. 8, 2016

(54) SMARTPHONE CAMERA USER INTERFACE

(71) Applicant: String Theory, Inc., Los Angeles, CA (US)

(72) Inventor: Jared S. Morgenstern, Los Angeles, CA (US)

(21) Appl. No.: 15/174,805

(22) Filed: Jun. 6, 2016

Related U.S. Application Data
(60) Provisional application No. 62/170,830, filed on Jun. 4, 2015.

(51) Int. Cl. H04N 5/232; H04N 5/225

(52) U.S. Cl. CPC H04N 5/23293; H04N 5/2258

(57) ABSTRACT

The camera system disclosed herein provides a seamless method of enabling people who are recording video to share their perspectives using multiple cameras easily and conveniently using a technique called cam flip. One system allows you to start recording video of yourself, and then after recording starts use a simple swipe up gesture to continue to record what you're looking at. You can swipe down to show your face again, optionally swiping up and down as many times as you want to switch cameras, without pausing the video. The resultant output can be sent to a server or saved to a camera roll or streamed.

### CROSS-REFERENCE TO RELATED APPLICATIONS

The present application claims benefit of priority to U.S. Provisional Patent Application No. 62/170,830, entitled “Smartphone Camera User Interface” and filed on Jun. 4, 2015, which is specifically incorporated by reference for all that it discloses and teaches.

### FIELD

Implementations disclosed herein relate, in general, to information management technology and specifically to video recording.

### SUMMARY

The recording system disclosed herein, referred to as cam flip, provides for a method of enabling someone recording a video to seamlessly switch which camera is recording.

In one implementation of cam flip, a simple touch gesture of swiping up switches from the front (self) facing camera to the back (away) facing camera and simple touch gesture of swiping down switches from the back (away) facing camera to the front (self) facing camera. If there are more than 2 cameras, this technique can still be used to cycle cameras. Note that while in this implementation an up gesture switches from front to back facing camera and vice versa, in an alternative implementation, an up gesture may switch from back to front and a down gesture may flip the camera from front to back.

Yet alternatively, the up and down gestures may also be replaced by right and left gesture, thus for example a gesture of a finger, thumb, etc., to right may switch from front facing camera to back facing camera and a gesture to left may switch the camera from back facing to front facing, or vice-versa. The user inputs to cam flip do not even need to be restricted to swipes as we believe it is novel to just switch cameras during a recording session as being directed by user input, of which a simple swipe gesture is our chosen implementation.

In one implementation of cam flip, the camera can be flipped multiple times to switch perspective from the person recording, to what they're looking at based on multiple cameras.

In one implementation of cam flip, these swipes and switches can only occur after recording is started (e.g. 1 second into the recording); in another, only prior to recording, and in another, at either time. If the flipping occurs during recording, flipping does not pause the recording.

In one implementation of cam flip, recording must begin using a particular camera, such as the front facing camera, such that all recordings start with seeing the person, and then optionally, they can show what they are looking at using other cameras, and optionally cycle them, etc.

In one implementation of cam flip, the recording is the stitched together output of the cameras that were recording and can be streamed live or saved to a camera roll or uploaded to a server for distribution.

In another implementation of cam flip, the output of all cameras is sent to the server, along with the information of which was the currently being focused on by the user, so that all the output can be used for optimal later distribution and display.

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates one implementation of cam flip where the camera is recording from the self facing camera and the user indicates a desire to flip the camera by swiping up and observes the display pane rotate to what they are looking at using the other camera.

FIG. 2 illustrates how a user can cycle between recording cameras with cam flip.

FIG. 3 is an example flow chart depicting an implementation of cam flip user interface.

FIG. 4 illustrates an example view of a user using a smartphone with cam flip.

FIG. 5 illustrates an example view of a user using a smartphone with cam flip gesture.

FIG. 6 illustrates an example view of a user using a smartphone with cam flip user interface resulting in alternative camera orientation.

FIG. 7 illustrates another example view of a user using a smartphone with cam flip gesture.

FIG. 8 illustrates another example view of a user using a smartphone with cam flip resulting in alternative camera orientation.

FIG. 9 illustrates an example output media generated by a user using a smartphone camera with cam flip user interface.

FIG. 10 illustrates an example system that may be useful in implementing the described technology.

FIG. 11 illustrates an example mobile device that may be useful in implementing the described technology.

### DETAILED DESCRIPTION

The recording system disclosed herein, referred to as cam flip, provides for a method of enabling someone recording a video to seamlessly switch which camera is recording. This is especially useful if someone is telling a story and wants to talk to you and also show you what they are looking at.

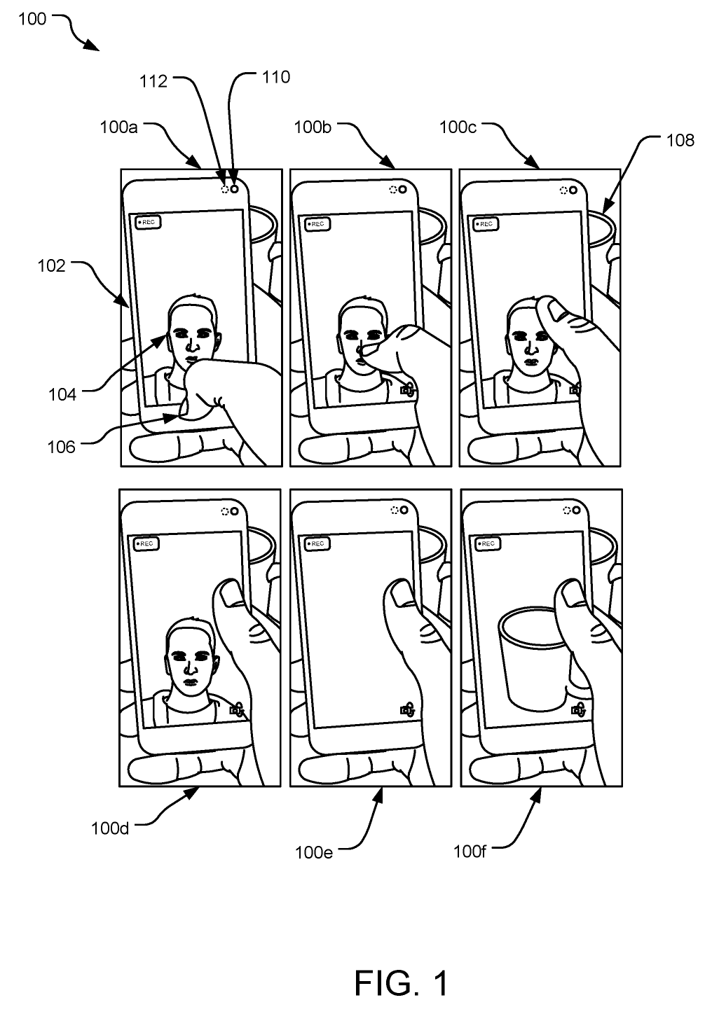

FIG. 1 illustrates a plurality of images 100 illustrating one implementation of cam flip user interface on a smartphone where the camera is recording from the self facing camera and the user indicates a desire to flip the camera by swiping up and observes the display pane switch to what they are looking at using the other camera. The first image 100a shows the user recording with the self-facing camera 110. The user's image 104 is presented on the screen of the device 102, and the finger or thumb is in a neutral position. The second image 100b shows the user placing their finger or thumb 106 on the surface of the device 102, while still recording with the self-facing camera 110. Image three 100c shows the user beginning the gesture of swiping vertically upward with their finger or thumb 106 on the screen of the device 102. Image four 100d further shows the user swiping upward with their finger or thumb 106 on the screen of the device 102. In image five 100e the display pane switches away from the self-facing camera 110. In image six 100f the device 102 has switched from the self-facing camera 110 to the away facing camera 112. The image of the object 108 in front of the user is now displayed on the screen of device 102.

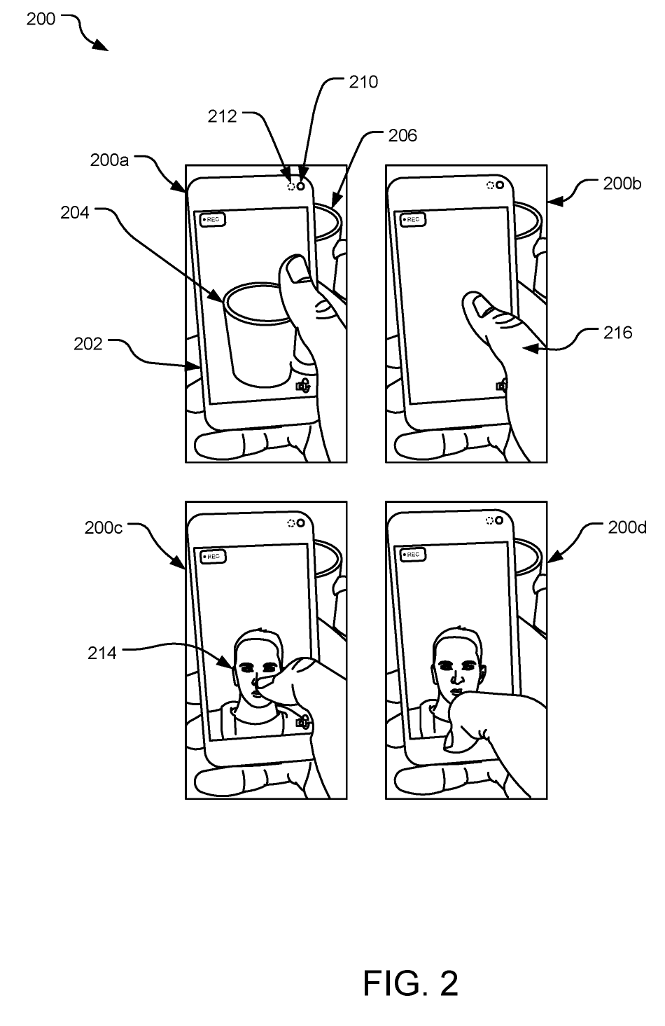

FIG. 2 illustrates a plurality of images 200 illustrating how a user can cycle between recording cameras. The first image 200a shows image capture on device 202 of an object 206 in front of the user, using the away-facing camera 212. The object 206 in front of the user is recorded by the away-facing camera 212 and displayed 204 on the screen of the device 202. The first image 200a shows the user initializing a downward swipe using a finger or thumb 216. In the second image 200b the user has initialized the downward swipe using a finger or thumb 216, resulting in cam flip cycling between away-facing 212 and self-facing camera 210 views. In image three 200c cam flip is completing the switch from away-facing camera 212 to self-facing camera 210, displaying the image of the user 214. In image four 200d the user has completed the downward swipe with a finger or thumb 216 and the recording camera has switched from the away-facing camera 212 to the self-facing camera 210. Note that while the illustrations of FIG. 2 are still images, in reality, the first to the third images (200a-200c) represents a continuous video where some of the video is captured by a front facing camera and some of the video is captured by the camera facing away from the user.

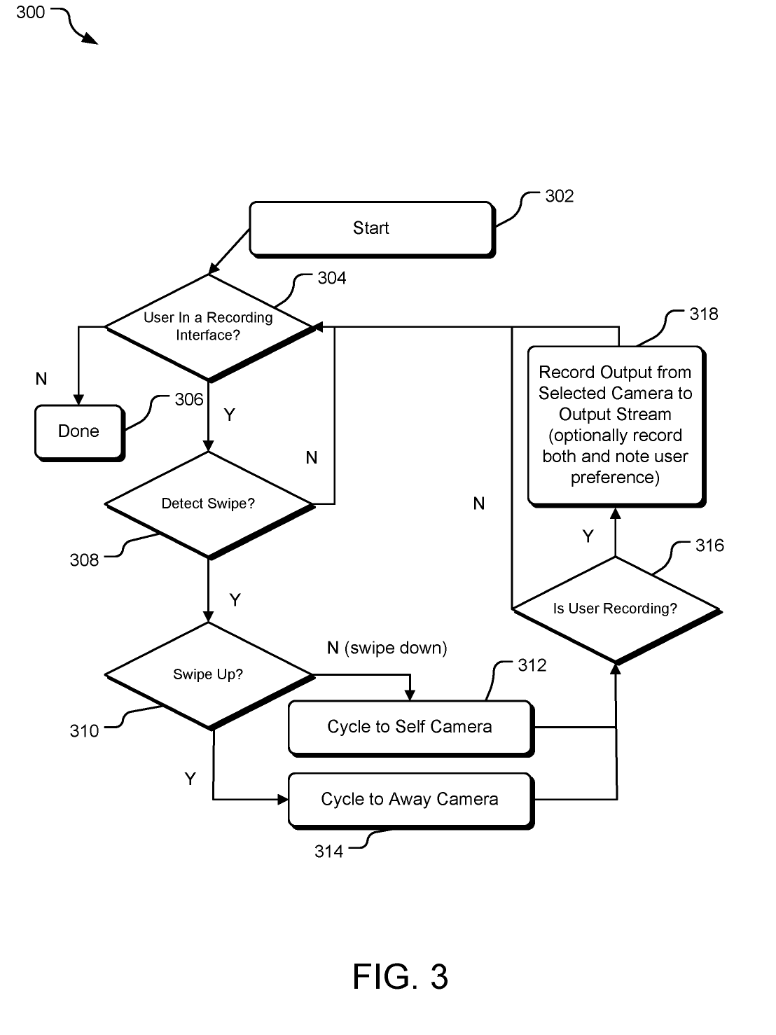

FIG. 3 is an example flowchart 300 depicting an implementation of cam flip. Cam flip begins by determining whether the user has entered a recording interface 302. If a user is not currently using a recording interface, cam flip operations are not available. After a user has entered a recording interface, the smartphone's swipe detection is enabled 304. For example, a user may use his finger or thumb to make a vertical swipe up or down on a smartphone touchscreen. If no swipe is detected, cam flip may standby while the user remains in a recording interface and continue monitoring for a user swipe. Upon detection of a vertical swipe, cam flip determines whether the swipe was up 306. If the user swiped up, cam flip cycles the recording camera to the away-facing camera 308. For example, once cam flip detects an up swipe, the recording camera will cycle to record the image of the object in front of the user. If the user swiped down, cam flip cycles the recording camera to the self-facing camera 310. For example, once cam flip detects a down swipe, the recording camera will cycle to record the image of the user. Subsequently, an operation determines if the user is recording the output from the selected camera. If the user is recording, the outputs from both the away-facing and self-facing cameras are recorded to an output media stream. FIG. 3 depicts a system that detects a vertical swipe up or down. However, it would also be understood from this disclosure that a user may make a horizontal swipe left or right.

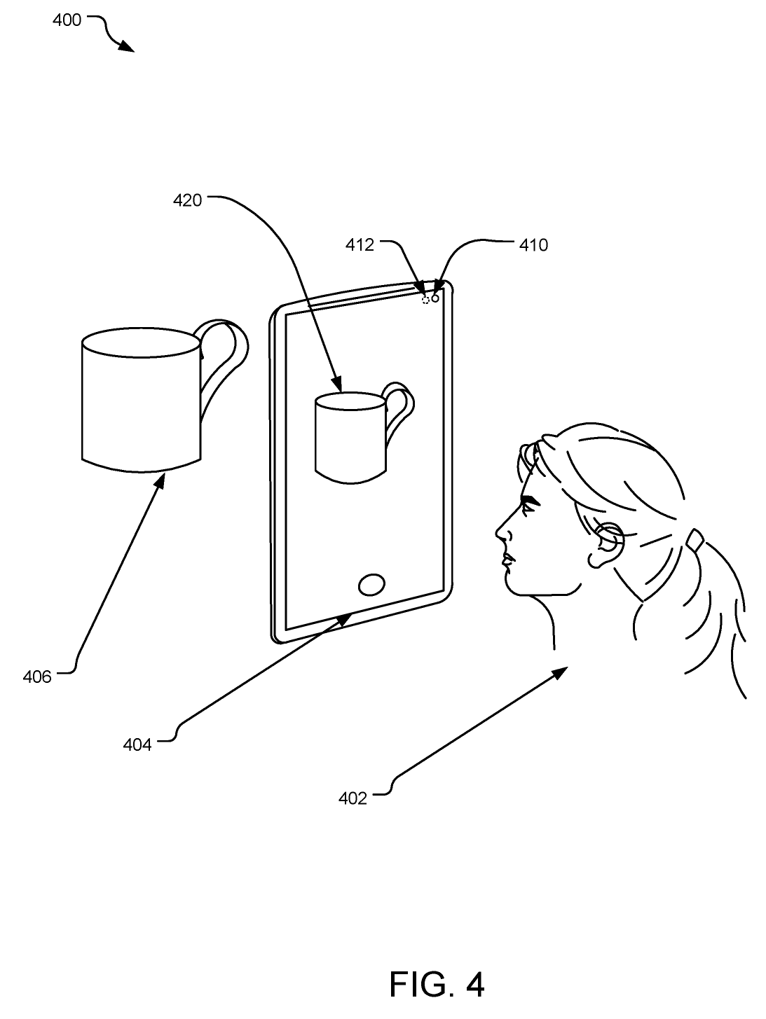

FIG. 4 illustrates an example view 400 of a user using a smartphone with cam flip feature. Specifically, in this view 400, the user 402 is using a device 404 with dual cameras—a self-facing camera 410 and an away-facing camera 412, such as a smartphone to record video of an object 406. While the away-facing camera 412 is active, the user 402 sees an image 420 of the object 406 displayed on the screen of the device 404.

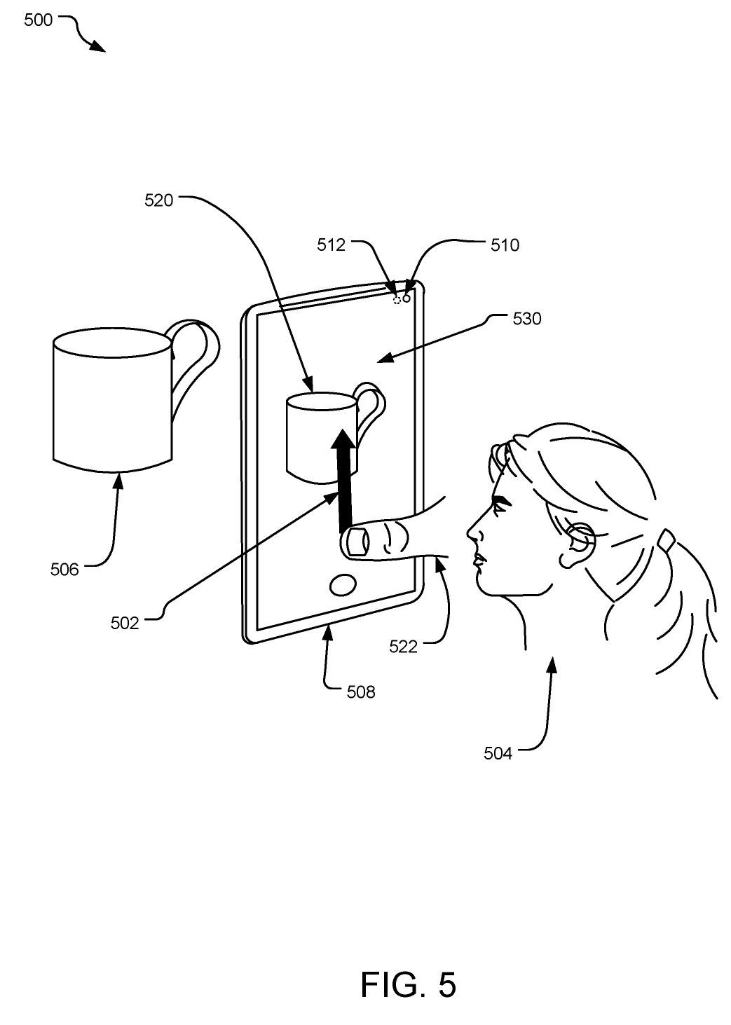

FIG. 5 illustrates an example view 500 of a user using a smartphone with a cam flip swipe 502 in an up direction or from the bottom of the device 508 towards the top of the device. In one implementation, if the device was held sideways (with the bottom and top aligned horizontally), a cam flip swipe 502 from either left to right or from right to left may be considered equivalent to a cam flip swipe 502 in the up direction. An implementation of a touch-sensitive touch screen 530 of device 508 allows user 504 to interact with the device 508. The touch-sensitive touch screen 530 recognizes touch events on the surface of the touch-sensitive touch screen 530 and outputs information about the touch events to the device 508. In alternative implementations, the device 508 may, for example, correspond to a computer such as a desktop, laptop, handheld, a phablet computer, or a tablet computer. The device 508 interprets the touch events and thereafter performs an action based on the touch events. The touch-sensitive touch screen provides an input interface and an output interface between the device 508 and the user 504. The touch-sensitive touch screen 530 displays visual output to the user 504 in response to one or more of the touch events.

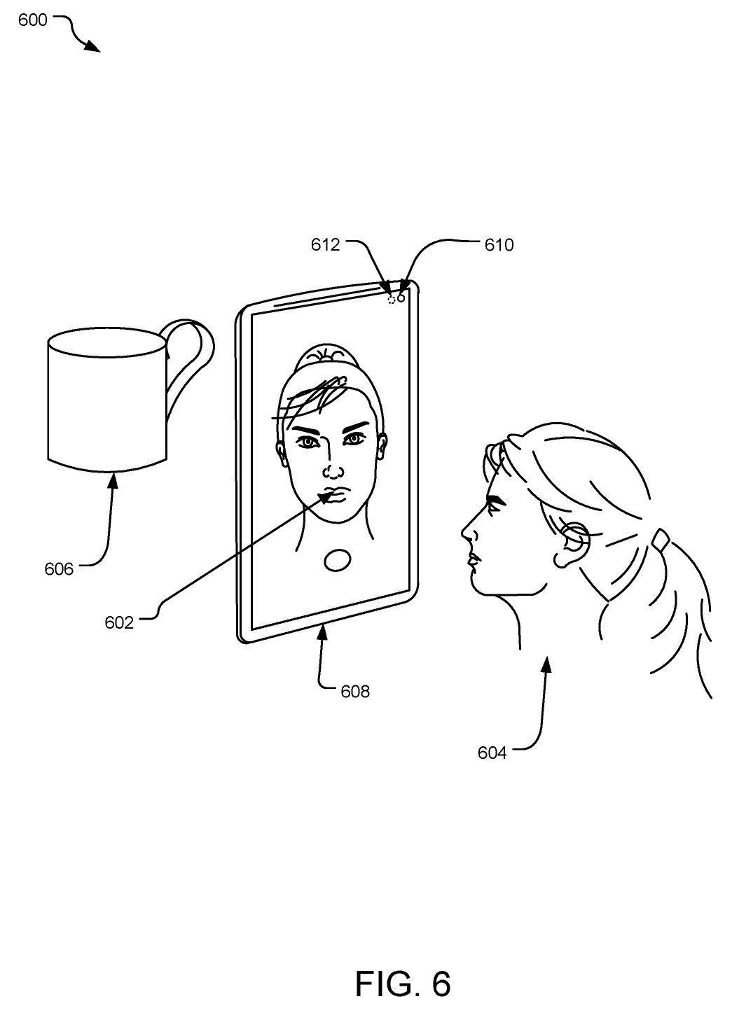

The visual output may include graphic, text, icons, video, and any combination thereof. The touch-sensitive touch screen 530 has a touch-sensitive surface, sensor or set of sensors that accepts input from the user 504 based on haptic and/or tactile contact. The touch-sensitive touch screen 530 detects contact on the surface and converts the detected contact into interaction with user-interface objects that are displayed on the touch-sensitive touch screen 530. The touch-sensitive touch screen 530 may detect contact and any movement using a plurality of touch sensing technologies now known or later developed, including but not limited to capacitive, resistive, infrared, and surface acoustic wave technologies, as well as other proximity sensor array or other elements for determining interaction with the touch-sensitive touch screen 530 surface. User 504 uses a finger or thumb 522 to interact with the touch-sensitive touch screen 530 surface of the device 508. When the touch-sensitive touch screen 530 of device 508 senses an upward vertical swipe 502 of finger or thumb 522, cam flip cycles the the recording camera from an away-facing camera 512 to a self-facing camera 510. The result of the upward vertical swipe 502 is illustrated in FIG. 6.

Specifically, FIG. 6 illustrates an example view 600 of the user 608 using a smartphone with cam flip user interface resulting in alternative camera orientation. Specifically, while the image 500 illustrates the camera facing an object, the image 600 illustrates the camera capturing the user's image 602. The user's image 602 is captured by the self-facing camera 610.

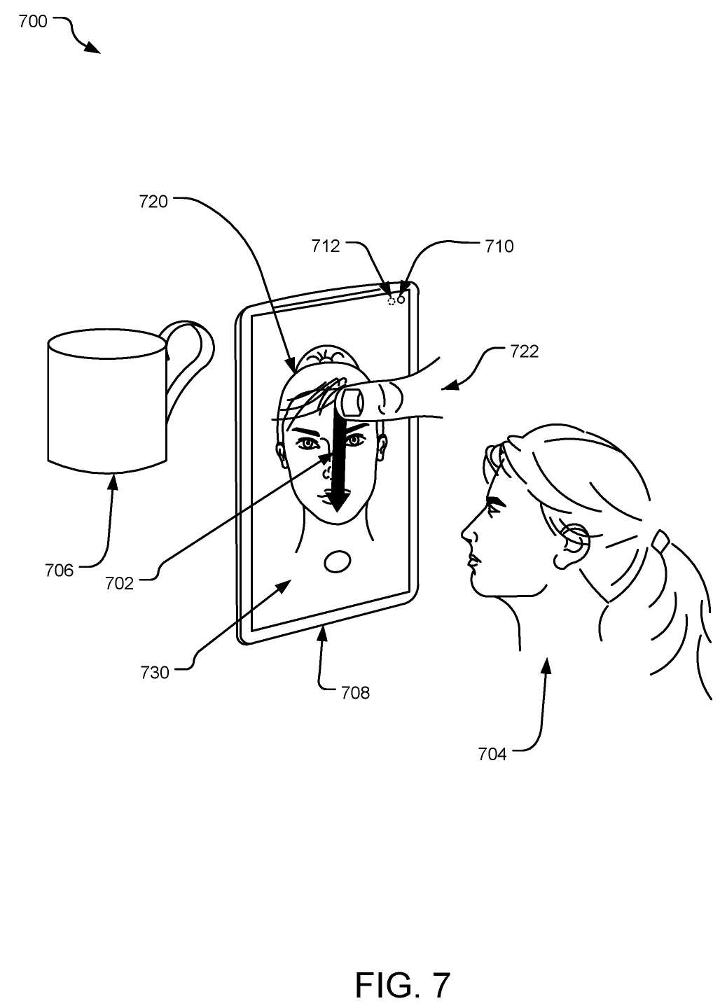

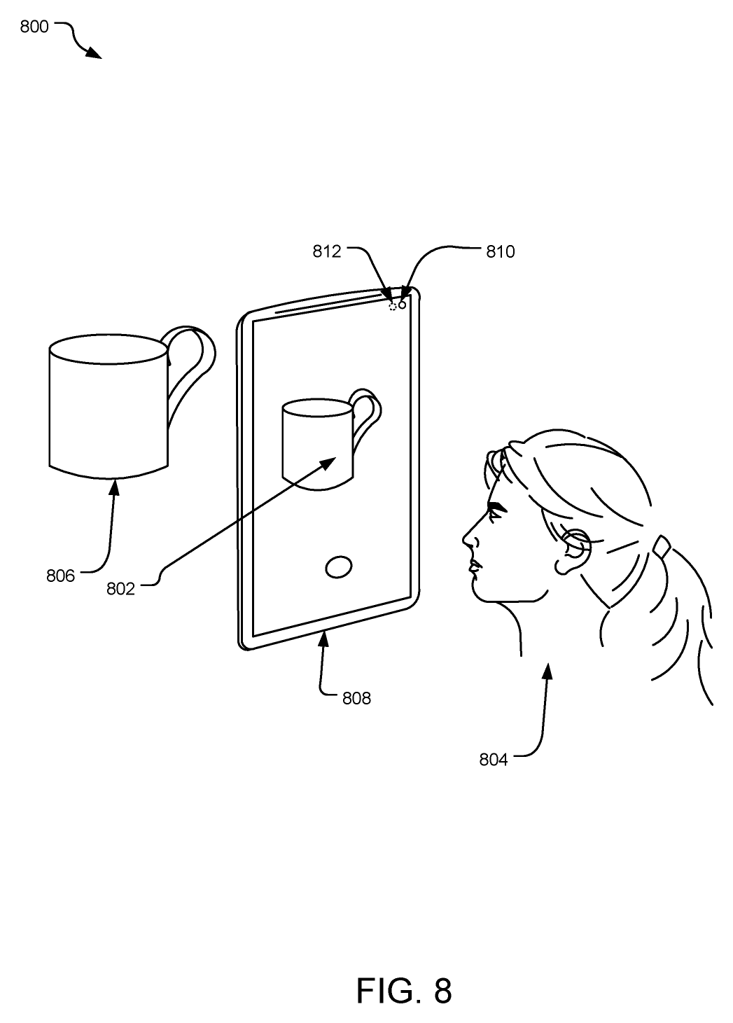

FIG. 7 illustrates another example view 700 of a user using a smartphone with cam flip swipe 702 in a down direction. User 704 uses a finger or thumb 722 to interact with the touch-sensitive touch screen 730 of the device 708. When the touch-sensitive touch screen 730 of device 708 senses a downward vertical swipe 702 of finger or thumb 722, cam flip cycles the recording camera from the self-facing camera 710 to the away-facing camera 712. The result of the downward vertical swipe 702 is illustrated in FIG. 8.

Specifically, FIG. 8 illustrates another example view 800 of a user 808 using a smartphone with cam flip resulting in alternative camera orientation. Specifically, while the image 700 illustrates the camera facing the user, the image 800 illustrates the camera capturing an image 802 of an object 806 facing the camera on the other side of the user 804. The object's image is captured by the away-facing camera 812.

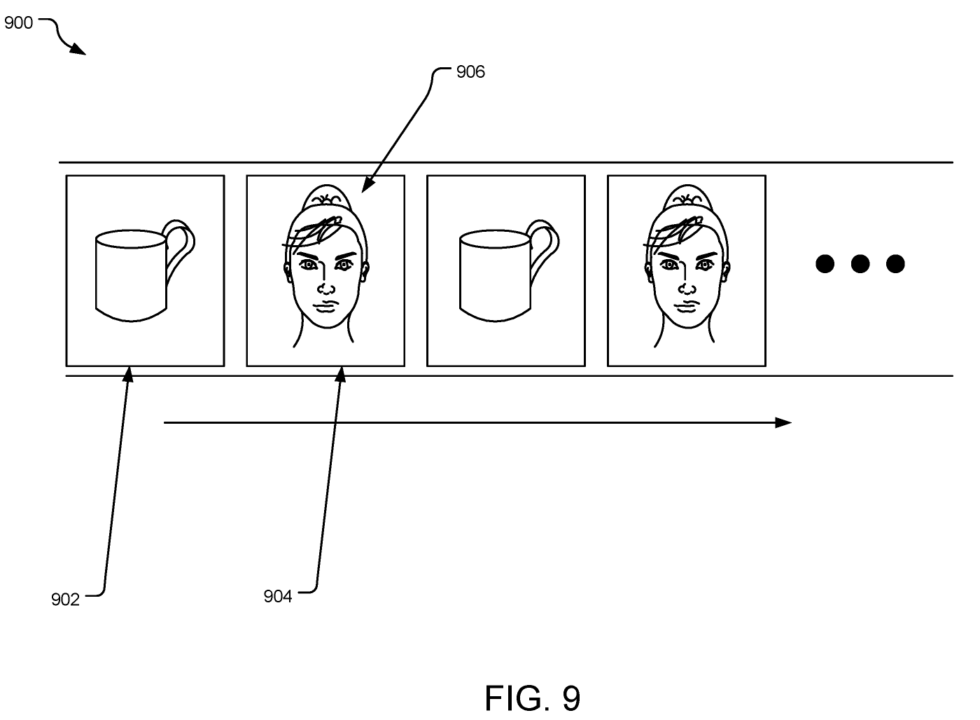

FIG. 9 illustrates an example output media 900 generated by a user using a smartphone camera with cam flip user interface. As illustrated by the output media 900, the user may have started recording the media (in this case a movie) when the camera is recording an object in front of the user, as captured at 902. When the user flips the camera using the camera flip gesture by swiping a finger, etc., on the screen of the smartphone, the camera facing the user starts recording the user, resulting in the camera capturing the user as captured at 904. Furthermore, the user may keep using the cam flip gesture again and again to continue alternatively recording an object in front of her and her own image 906.

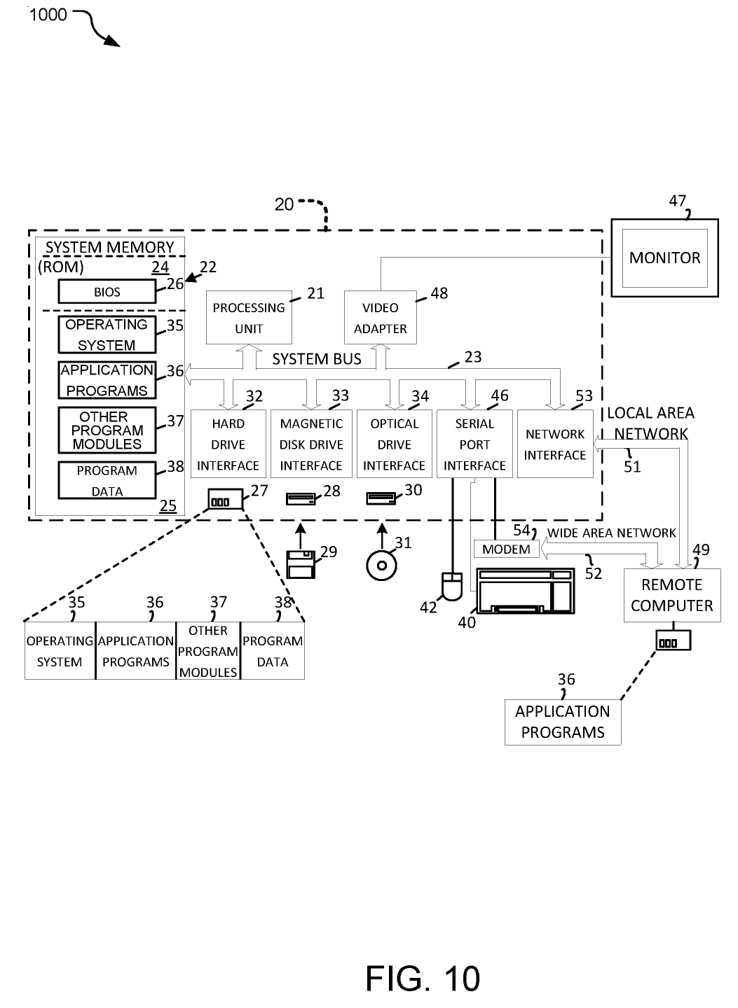

FIG. 10 illustrates an example system 1000 that may be useful in implementing the described technology for providing offline maps. The example hardware and operating environment of FIG. 10 for implementing the described technology includes a computing device, such as a general purpose computing device in the form of a computer 20, a mobile telephone, a personal data assistant (PDA), a tablet, smart watch, gaming remote, or other type of computing device. In the implementation of FIG. 10, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the implementations are not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide non-volatile storage of computer-readable instructions, data structures, program modules and other data for the computer 20. It should be appreciated by those skilled in the art that any type of tangible computer-readable media may be used in the example cam flip technology.

A number of program modules may be stored on the hard disk drive 27, magnetic disk 29, optical disk 31, ROM 24, or RAM 25, including an operating system 35, one or more application programs 36, other program modules 37, and program data 38. A user may generate reminders on the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device or other common network node, and typically includes many or all of the elements described above relative to the computer 20. The logical connections depicted in FIG. 10 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are examples and other means of communications devices for establishing a communications link between the computers may be used.

In an example implementation, software or firmware instructions for providing offline maps may be stored in memory 22 and/or storage devices 29 or 31 and processed by the processing unit 21. Rules for providing offline maps may be stored in memory 22 and/or storage devices 29 or 31 as persistent datastores. For example, an offline map download module may be implemented with instructions stored in the memory 22 and/or storage devices 29 or 31 and processed by the processing unit 21. Similarly, a GPS parameter processing module may also be implemented with instructions stored in the memory 22 and/or storage devices 29 or 31 and processed by the processing unit 21. The memory 22 may be used to store one or more offline maps. In one implementation, the memory 22 may store a camera cycling module executable by the one or more processor units, the camera cycling module configured to detect a direction of a swipe on a user interface surface and in response to the detection, cycle between a self facing camera and an away facing camera based on the direction of the swipe gesture.

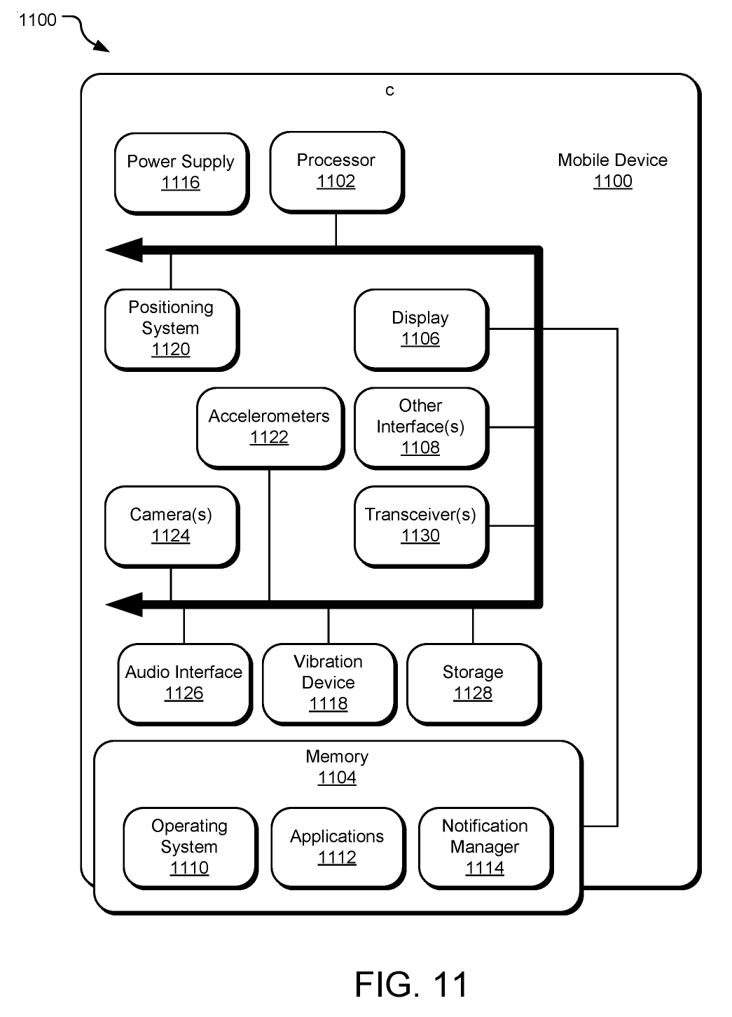

FIG. 11 illustrates another example system (labeled as a mobile device 1100) that may be useful in implementing the described cam flip technology. The mobile device 1100 includes a processor 1102, a memory 1104, a display 1106 (e.g., a touchscreen display), and other interfaces 1108 (e.g., a keyboard). The memory 1104 generally includes both volatile memory (e.g., RAM) and non-volatile memory (e.g., flash memory). An operating system 1110 resides in the memory 1104 and is executed by the processor 1102, although it should be understood that other operating systems may be employed.

One or more application programs 1112 are loaded in the memory 1104 and executed on the operating system 1110 by the processor 1102. Examples of application programs 1112 include without limitation email programs, scheduling programs, personal information managers, Internet browsing programs, multimedia player applications, etc. An implementation of the mobile device 1100 may include application programs 1112 used for providing the cam flip capabilities to the mobile device 1100. A notification manager 1114 is also loaded in the memory 1104 and is executed by the processor 1102 to present notifications to the user. For example, when a promotion is triggered and presented to the shopper, the notification manager 1114 can cause the mobile device 1100 to beep or vibrate (via the vibration device 1118) and display the promotion on the display 1106.

The mobile device 1100 includes a power supply 1116, which is powered by one or more batteries or other power sources and which provides power to other components of the mobile device 1100. The power supply 1116 may also be connected to an external power source that overrides or recharges the built-in batteries or other power sources.

The mobile device 1100 includes one or more communication transceivers 1130 to provide network connectivity (e.g., mobile phone network, Wi-Fi®, Bluetooth®, etc.). The mobile device 1100 also includes various other components, such as a positioning system 1120 (e.g., a global positioning satellite transceiver), one or more accelerometers 1122, one or more cameras 1124, an audio interface 1126 (e.g., a microphone, an audio amplifier and speaker and/or audio jack), and additional storage 1128. Other configurations may also be employed.

What is claimed is:

1. A physical article of manufacture including one or more tangible computer-readable storage media, encoding computer-executable instructions for executing on a computer system a computer process, the computer process comprising:
detecting a direction of a swipe on a user device; and
in response to the detection, cycling between two cameras of the user device based on the direction of the swipe.

2. The physical article of manufacture of claim 1, wherein detecting a direction of the swipe gesture further comprises detecting a direction of the swipe gesture on a surface of the user device.

3. The physical article of manufacture of claim 1, wherein the user device is a smartphone.

4. The physical article of manufacture of claim 1, wherein the user device is a tablet device.

5. The physical article of manufacture of claim 1, wherein in response to a swipe gesture from bottom of the user device to a top of the user device, the cycling between two cameras of the user device comprises cycling from a self-facing camera to an away-facing camera.

6. The physical article of manufacture of claim 1, wherein in response to a swipe gesture from bottom of the user device to a top of the user device, the cycling between two cameras of the user device comprises cycling from a self-facing camera to an away-facing camera.

7. The physical article of manufacture of claim 1, wherein in response to a swipe gesture from top of the user device to a bottom of the user device, the cycling between two cameras of the user device comprises cycling from an away-facing camera to a self-facing camera.

8. A method comprising:
detecting a direction of a swipe on a surface of a user device; and
in response to the detection, cycling between two cameras of the user device based on the direction of the swipe.

9. The method of claim 8, wherein the user device is one of a smartphone, a tablet computer, a phablet computer, and a desktop computer.

10. The method of claim 8, wherein detecting a direction of the swipe gesture further comprises detecting a direction of the swipe gesture on a surface of the user device.

11. The method of claim 8, wherein in response to a swipe gesture from a top of the user device to a bottom of the user device, the cycling between two cameras of the user device comprises cycling from an away-facing camera of the user device to a self-facing camera of the user device.

12. The method of claim 8, wherein in response to a swipe gesture from a bottom of the user device to a top of the user device, the cycling between two cameras of the user device comprises cycling from a self-facing camera of the user device to an away-facing camera of the user device.

13. An apparatus comprising:
memory;
one or more processor units;
a self facing camera and an away facing camera;
a user interface surface configured to detect direction of a swipe by a user;
a camera cycling module stored in the memory and executable by the one or more processor units, the camera cycling module configured to detect a direction of a swipe on a user interface surface and in response to the detection, cycle between the self facing camera and the away facing camera based on the direction of the swipe.

14. The apparatus of claim 13, wherein the apparatus is a smartphone.

15. The apparatus of claim 13, wherein the apparatus is a tablet.
